(19) United States
(12) Patent Application Publication
(10) Pub. No.: US 2012/0271875 A1
(43) Pub. Date: Oct. 25, 2012

(54) Method, Apparatus and System for Gathering E-Commerce Website Information

(75) Inventor: Jingzhu Cai, Hangzhou (CN)

(73) Assignee: ALIBABA GROUP HOLDING LIMITED, Grand Cayman (unknown)

(21) Appl. No.: 13/059,489

(22) PCT Filed: Oct. 26, 2010
(86) PCT No.: PCT/US10/54095

§ 371 Date: Feb. 17, 2011

(30) Foreign Application Priority Data
Jan. 13, 2010 (CN) 201010003411.8

(51) Int. Cl. G06F 15/16

(52) U.S. Cl. 709/203

(57) ABSTRACT

The present disclosure describes a method, apparatus and system for gathering e-commerce website information that optimizes website data gathering. A disclosed method comprises: receiving, by a server from a client, a product information request message containing a product ID and a URL; communicatively coupling to a webpage corresponding to the URL; scanning the webpage for the product ID; gathering information related to the product ID; and transmitting the gathered information to the client. In this manner, webpage data collection is significantly simplified and data gathering optimized. The present disclosure also discloses a website server and an e-commerce system.

### CROSS REFERENCE TO RELATED PATENT APPLICATIONS

This application is a national stage application of an international patent application PCT/US10/54095, filed Oct. 26, 2010, which claims priority from Chinese Patent Application No. 201010003411.8, filed Jan. 13, 2010, entitled “Method, Apparatus and System for Gathering E-Commerce Website Information,” which applications are hereby incorporated in their entirety by reference.

### TECHNICAL FIELD

The present disclosure relates to the field of computers and, more particularly, to the method, apparatus, and system for gathering e-commerce website information.

### BACKGROUND

With the development of e-commerce technologies, various kinds of e-commerce websites have emerged. Correspondingly, the number of network users has also increased. This indicates a surrogate relationship between the network users and the e-commerce websites. E-commerce websites display products to be sold to the users. Users often visit an e-commerce website to acquire the latest product information, such as name, images and specifications of the product. After gathering the related product information, they may distribute the information to other e-commerce websites.

With the existing technology, a user generally downloads product information from one or more webpages one by one. This is because if the whole webpage is directly copied, the information may be dislocated. As a result the name, image, and brief details of the product might not correspond to one another. However, with the increasing volume of businesses, downloading one by one can be a waste of time and energy. Furthermore, network users often download redundantly. Thus, it reduces the efficiency and accuracy of information gathering and produces great inconvenience to the user.

### SUMMARY OF THE DISCLOSURE

The present disclosure provides exemplary implementation of a method, apparatus, and system for gathering e-commerce website information used to optimize website data gathering.

According to one aspect, a method of gathering website information may comprise: receiving, by a server from a client, a product information request message containing a product identification (ID) and a uniform resource locator (URL); communicatively coupling to a webpage corresponding to the URL; scanning the webpage for the product ID; gathering information related to the product ID; and transmitting the gathered information to the client.

In one embodiment, prior to receiving the product information request message, the server may conduct a verification of the client's identity.

In one embodiment, scanning the webpage for the product ID may comprise scanning content of the webpage and a designated region of the webpage corresponding to the product.

In one embodiment, gathering information related to the product ID may comprise: arranging the gathered information according to a respective upload time of each piece of information; and filtering out information having a respective upload time that is after a predetermined time.

In one embodiment, gathering information related to the product ID may comprise comparing the gathered information and information previously provided to the client to filter out redundant information from the gathered information.

According to another aspect, a website server may comprise: a reception unit that receives from a client a product information request message containing a product ID and an URL; a scanning unit that communicatively couples to a webpage corresponding to the URL and scans the webpage for the product ID; a gathering unit that gathers information related to the product ID; and a transmission unit that transmits the gathered information to the client.

In one embodiment, the website server may further comprise a verification unit that conducts a verification of the client's identity. After gathering the information related to the product ID, the gathering unit may arrange pieces of the gathered information according to a respective upload time of each piece of gathered information and filters out those pieces of information having a respective upload time that is after a predetermined time to provide filtered information to the client. Alternatively or additionally, after gathering the information related to the product ID, the gathering unit may compare the gathered information with information provided to the client previously to filter out redundant information from the gathered information and provide the filtered information to the client.

In one embodiment, the scanning unit, when scanning the webpage based on the product ID, may scan a designated area of the webpage related to the product ID.

According to yet another aspect, a method of distributing website information may comprise: sending a product information request message that contains a product ID and a URL to a first website server which, based on the product information request message, communicatively couples to a webpage corresponding to the URL to gather information related to the product ID from the webpage; receiving the gathered information from the first web server; and sending the gathered information to a second website server to distribute the gathered information.

In one embodiment, sending the gathered information to the second website server to distribute the gathered information may comprise: determining one or more webpages related to the product ID on the second website server; and distributing the gathered information on the one or more webpages related to the product ID.

In one embodiment, the product ID may comprise one or more product identifications.

According to still another aspect, a network device may comprise: a transmission unit that sends a product information request message containing a product ID and a URL to a first website server to direct the first website server to communicatively couple to a webpage corresponding to the URL to gather information related to the product ID; a reception unit that receives the gathered information from the first website server; and a distribution unit that sends the gathered information to a second website server which distributes the gathered information.

In one embodiment, the distribution unit may determine one or more webpages related to the product ID on the second website server and cause the gathered information to be distributed on the one or more webpages related to the product ID.

In one embodiment, a website server receives a client's product information request message. The website server then scans a webpage for the product ID, gathers website information related to the product ID, and sends the gathered information to the client. In this manner, webpage data collection is significantly simplified and data gathering optimized. Furthermore, the technique can arrange the information beforehand, thus increasing the accuracy of information and quality of the website service. On the other hand, with a first website server gathering the website information which is sent to a second website server for distribution, distribution of the gathered information is optimized.

### DESCRIPTION OF DRAWINGS

FIG. 1 shows a diagram of the 1^{st} network environment according to an embodiment of the present disclosure.

FIG. 2 shows a diagram of web server functional modules according to an embodiment of the present disclosure.

FIG. 3 shows a flowchart of gathering webpage information according to an embodiment of the present disclosure.

FIG. 4 shows a diagram of the 2^{nd} network environment according to an embodiment of the present disclosure.

FIG. 5 shows a diagram of client function modules according to an embodiment of the present disclosure.

### DETAILED DESCRIPTION

In order to enhance the efficiency in gathering website information, the present disclosure provides an exemplary implementation of receiving a client request message for product information, where the product information request message contains a product ID and a URL that allows a website server to communicatively couple to a product webpage corresponding to this URL. The webpage is then scanned for the aforementioned product ID. The website information related to the product ID is gathered and sent to the client.

The following diagrams illustrate an exemplary implementation of the present disclosure.

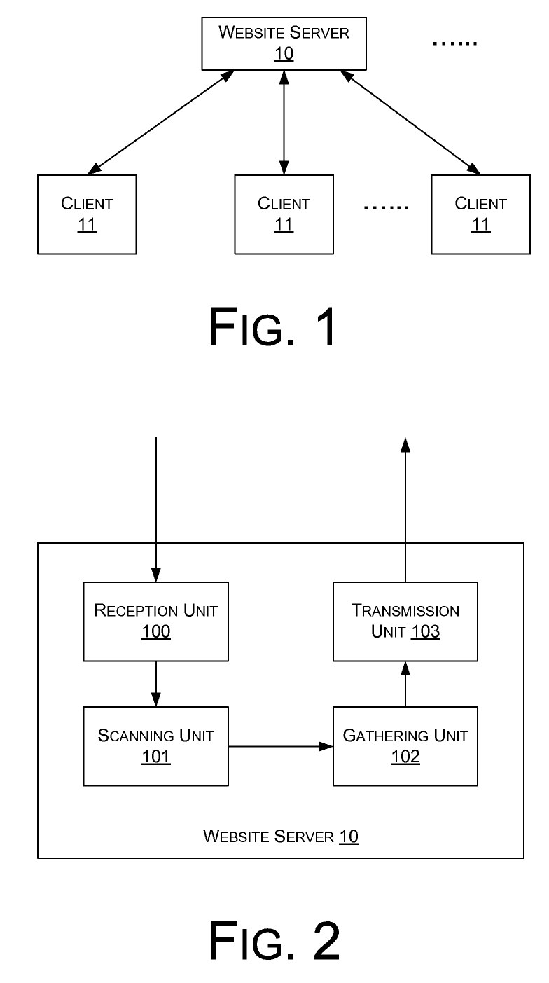

As shown in FIG. 1, a network environment includes a Website Server 10 and a Client 11.

Client 11 uses Website Server 10 to receive the product information request message that contains the product ID and URL.

Website Server 10 communicatively couples to the corresponding product webpage based on the URL, scans the webpage for the aforementioned product ID, gathers website information related to the product ID, and sends the information to the Client 11.

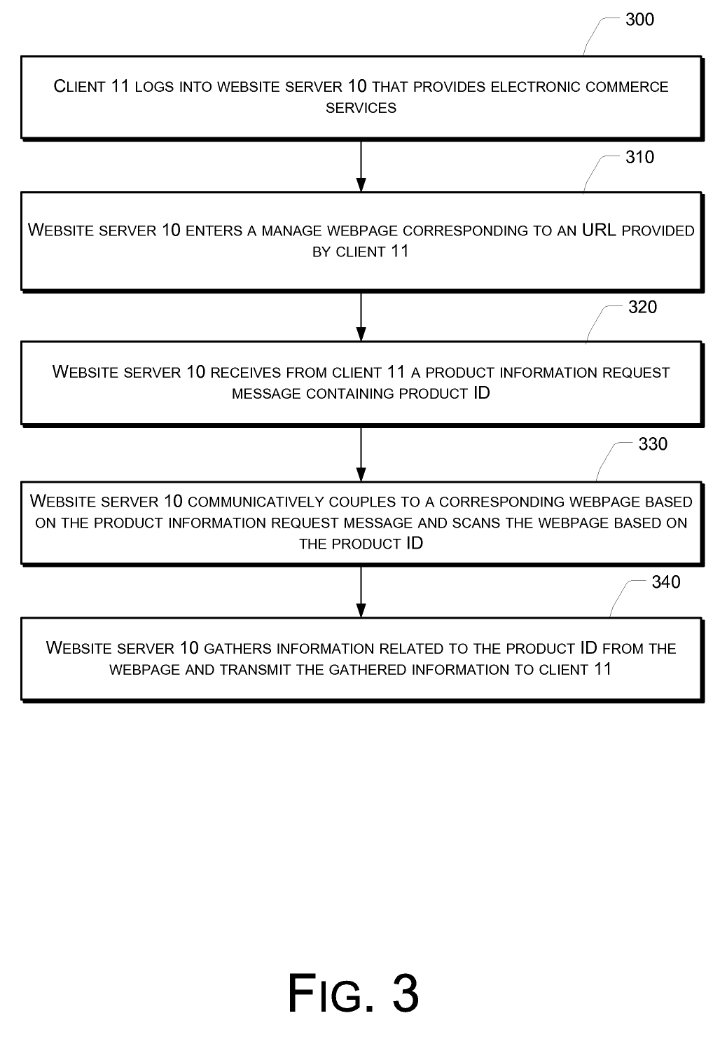

As shown in FIG. 2, an embodiment of web server functional modules includes the Website Server 10, Reception Unit 100, Scanning Unit 101, Gathering Unit 102, and Transmission Unit 103.

The Reception Unit 100 is used for receiving the client's product information request message containing the product ID and URL.

The Scanning Unit 101 is used for communicatively coupling, or linking, to the corresponding product webpage of the URL and scanning the webpage for the aforementioned product ID.

The Gathering Unit 102 is used for gathering website information related to the product ID.

The Transmission Unit 103 is used for sending gathered website information to the client.

Based on the aforementioned network environment, the following illustrates a detailed exemplary implementation.

As shown in FIG. 3, a process in which Website Server 10 gathers website information is described below.

At 300, the Website Server 10 offers the Client 11 e-commerce service login.

For practical applications, some website servers 10 may demand user verification before offering complete website information. Accordingly, Client 11 may have a choice to register to obtain the complete website information or, alternatively, not to login and only obtain part of the website information.

At 310, the Website Server 10 administers the website through an URL address provided by the user.

Generally, network users of Website Server 10 may have their own backstage support to manage products. Thus, as long as a network user inputs the URL address of the product support webpage, the network user can manage the website. The content of a webpage can be something like Table 1 below.

TABLE 1

| Product | Product | Retail | Agent | |
|---|---|---|---|---|
| Number | Name | Price | Price | Inventory |
| 0012 | Polo Shirt | 200.00 | 128.00 | 500 |
| 0013 | Men's | 150.00 | 100.00 | 200 |
| | Wallet | | | |

At 320, the Website Server 10 receives the client's product information request message containing the product ID and URL.

As shown in Table 1, product names can be set up in a web link form (e.g., a HTML link). In this manner, the user can click on the product name in Table 1 and, accordingly, the Website Server 10 receives the product information request message containing the URL address and product ID. Website Server 10 also gathers the latest website information related to the product ID.

At 330, the Website Server 10 communicatively couples to the corresponding product webpage, and scans the webpage for the aforementioned product ID.

For practical applications, because the webpage may contain a large quantity of non-commodity related information (such as webpage name, webpage title, webpage introduction and its sidebar selection), the Website Server 10 can also scan only related information (e.g., the “product details” area of the webpage, the “latest product description” area of the webpage, etc.).

At 340, the Website Server 10 gathers website information related to the product ID and sends it to the client.

For practical applications, the Website Server 10 can either send the information directly to the Client 11 after gathering the corresponding product website information or collate the gathered information first before sending. When collating the information (e.g., the product ID is “jeans” for example), the Website Server 10 can gather related website information about jeans (e.g., comprising the image and related details) with the information arranged based on respective upload time. Any other information that is older than a specified time period may be deleted before sending the collated information to the Client 11. Alternatively, Website Server 10 can compare the information earlier sent to the client and then delete any redundant information.

Upon receiving the information sent by the Website Server 10, the Client 11 can either save the information into a database of Client 11 or send the information out to other e-commerce websites for distribution. Specifically, the Client 11 may send the product information request message containing the URL and product ID to a first website server. The first website server then communicatively couples to one or more web pages corresponding to the URL and gathers website information related to the product ID. Subsequently, the Client 11 receives the information from the first website server and sends out the obtained website information to a second website server for distribution.

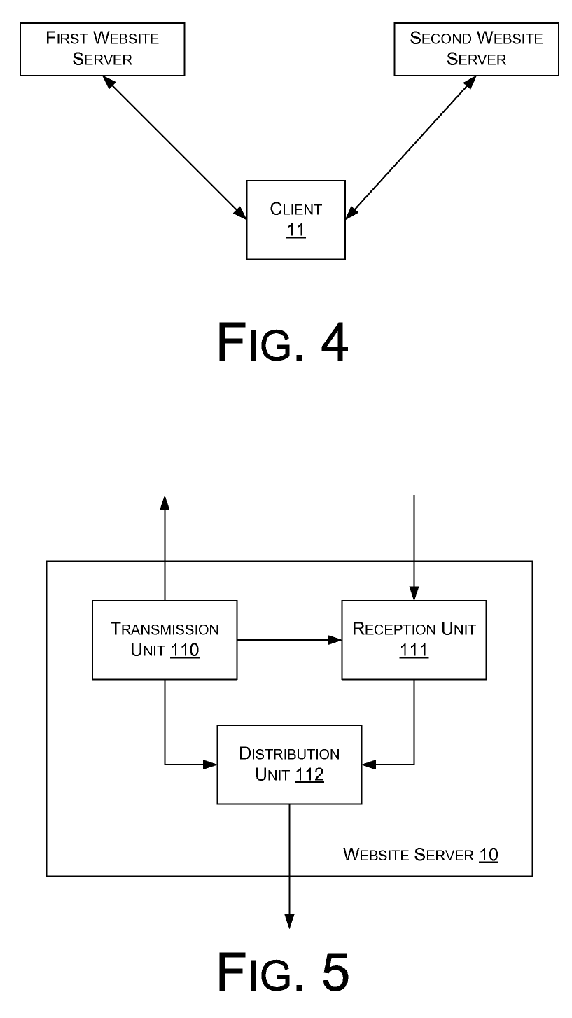

As shown in FIG. 4, an embodiment of an e-commerce system comprises the Client 11, the first website server and the second website server.

The first website server is used for gathering the website information based on preferences of Client 11.

The Client 11 sends the product information request message, containing the URL and product ID, to the first website server. Moreover, the Client 11 also uses the first web server to communicatively couple to one or more web pages corresponding to the URL and gather website information related to the product ID. Subsequently, the Client 11 receives the information from the first website server and sends out the obtained website information to the second website server for distribution.

The second website server is used to distribute the gathered website information based on preferences of the Client 11.

As shown in FIG. 5, an embodiment of the Client 11, a network device, comprises a Transmission Unit 110, a Reception Unit 111, and a Distribution Unit 112.

The Transmission unit 110 sends out the product information request message containing the product ID and URL to the first website server. The first website server communicatively couples to corresponding product webpage(s) of the URL and gathers website information related to the product ID.

The Reception unit 111 receives the gathered website information gathered.

The Distribution unit 112 sends the website information to the second website server for distribution.

By gathering one or more product IDs from the first website server, a client can obtain multiple product IDs at the same time and distribute related product information at the second website server. Given a product ID, Client 11 determines one or more webpages on the second website server where information related to the given product ID can be distributed. Afterwards, the Client 11 causes website information gathered by the first website server to be distributed on the determined one or more webpages on the second website server. For example, with the product ID being “jeans”, the Client 11 determines a webpage on the second website server where information related to product ID of “jeans” can be distributed. The Client 11 then causes the information gathered by the first website server to be distributed on this webpage on the second website server.

In one embodiment, the website server receives a product information request message from a client. It then scans the webpage for the product ID, gathers website information related to the product ID, and sends it to the client. In this manner, the process of webpage data collection is significantly simplified and data gathering optimized. Furthermore, the disclosed technique can also arrange the information beforehand, thus increasing the information accuracy and website service quality. On the other hand, the website information gathered in the first website server is sent to the second website server for distribution, thereby simplifying, optimizing, and speeding up the process of information distribution.

A person of ordinary skill in the art can alter or modify the present disclosure in many different ways without departing from the spirit and the scope of this disclosure. Accordingly, it is intended that the present disclosure covers all modifications and variation which falls within the scope of the claims of the present disclosure and their equivalent.

What is claimed is:

1. A method of gathering website information, comprising:
receiving, by a server from a client, a product information request message containing a product identification (ID) and a uniform resource locator (URL);
communicatively coupling to a webpage corresponding to the URL;
scanning the webpage for the product ID;
gathering information related to the product ID; and
transmitting the gathered information to the client.

2. The method as recited in claim 1, wherein prior to receiving the product information request message, the server conducts a verification of the client's identity.

3. The method as recited in claim 1, wherein scanning the webpage for the product ID comprises scanning content of the webpage and a designated region of the webpage corresponding to the product.

4. The method as recited in claim 1, wherein gathering information related to the product ID comprises:
arranging the gathered information according to a respective upload time of each piece of information; and
filtering out information having a respective upload time that is after a predetermined time.

5. The method as recited in claim 1, wherein gathering information related to the product ID comprises comparing the gathered information and information previously provided to the client to filter out redundant information from the gathered information.

6. A website server, comprising:
a reception unit that receives from a client a product information request message containing a product identification (ID) and a uniform resource locator (URL);
a scanning unit that communicatively couples to a webpage corresponding to the URL and scans the webpage for the product ID;
a gathering unit that gathers information related to the product ID; and
a transmission unit that transmits the gathered information to the client.

7. The website server as recited in claim 6, further comprising:
a verification unit that conducts a verification of the client's identity.

8. The website server as recited in claim 6, wherein the scanning unit, when scanning the webpage based on the product ID, scans a designated area of the webpage related to the product ID.

9. The website server as recited in claim 7, wherein, after gathering the information related to the product ID, the gathering unit arranges pieces of the gathered information according to a respective upload time of each piece of gathered information and filters out those pieces of information having a respective upload time that is after a predetermined time to provide filtered information to the client.

10. The web server as recited in claim 7, wherein, after gathering the information related to the product ID, the gathering unit compares the gathered information with information provided to the client previously to filter out redundant information from the gathered information and provides the filtered information to the client.

11. A method of distributing website information, comprising:
sending a product information request message that contains a product identification (ID) and a uniform resource locator (URL) to a first website server which, based on the product information request message, communicatively couples to a webpage corresponding to the URL to gather information related to the product ID from the webpage;
receiving the gathered information from the first web server; and
sending the gathered information to a second website server to distribute the gathered information.

12. The method as recited in claim 11, wherein sending the gathered information to the second website server to distribute the gathered information comprises:
determining one or more webpages related to the product ID on the second website server; and
distributing the gathered information on the one or more webpages related to the product ID.

13. The method as recited in claim 11, wherein the product ID comprises one or more product identifications.

14. A network device, comprising:
a transmission unit that sends a product information request message containing a product identification (ID) and a uniform resource locator (URL) to a first website server to direct the first website server to communicatively couple to a webpage corresponding to the URL to gather information related to the product ID;
a reception unit that receives the gathered information from the first website server; and
a distribution unit that sends the gathered information to a second website server which distributes the gathered information.

15. The network device as recited in claim 14, wherein the distribution unit determines one or more webpages related to the product ID on the second website server and causes the gathered information to be distributed on the one or more webpages related to the product ID.
